(19) United States
(12) Patent Application Publication
(10) Pub. No.: US 2007/0058650 A1
(43) Pub. Date: Mar. 15, 2007

(54) Resource buffer sizing under replenishment for services

(75) Inventor: John A. Ricketts, Clarendon Hills, IL (US)

Correspondence Address: Steven Fischman, Esq.;Scully, Scott, Murphy & Presser, 400 Garden City Plaza, Garden City, NY, 11530, US

(73) Assignee: INTERNATIONAL BUSINESS MACHINES CORPORATION, ARMONK, NY (US)

(21) Appl. No.: 11/200,706

(22) Filed: Aug. 9, 2005

(51) Int. Cl. H04L 12/56

(52) U.S. Cl. 370/412

(57) ABSTRACT

Disclosed are a method of and system for sizing service resource buffers. The method comprises the step providing a model for determining a buffer size and upper and lower thresholds for said buffer, said model including a plurality of parameters and constraints. Values for said parameters are entered into the model, and the model is solved. The method comprises the further steps of identifying at least one most sensitive of said parameters of said model, calibrating said at least one most sensitive of said parameters, and after said calibrating step, resolving the model to calculate the buffer size and the upper and lower thresholds for said buffer.

### BACKGROUND OF THE INVENTION

1. Field of the Invention

This invention generally relates to managing capacity in organizations that perform services. More specifically, the invention relates to resource buffer sizing in such organizations.

2. Background Art

Replenishment for Services is a technique for managing capacity in organizations that perform services, such as businesses, governments, and non-profit organizations. Although it can be used by any services organization, it is especially applicable in medium to large enterprises in Professional, Scientific, and Technical Services sector. This is so for a number of reasons. For instance, in this sector, practitioners often must be highly educated and attain a level of expertise in their field, thereby limiting the pool of resources able to accomplish specific tasks; and practitioners are often assigned to serve specific clients, thereby making them unavailable to serve additional clients.

In addition, in this sector, the degree of service customizations for each client is very high, thereby requiring practitioners to be adaptable, yet impeding their reassignment to new clients; and reliance on intellectual capital is very high, thereby requiring practitioners to contribute to its development while also keeping up with intellectual capital developed by others. Also, repeatability of processes is low compared to other services sectors, such as Health Care and Education, thereby requiring highly flexible resources.

These characteristics create considerable uncertainty in both the demand for and supply of qualified practitioners, thus making capacity management especially difficult. Using fixed capacity and managing capacity to annual plans are common approaches, but they may perform poorly as unexpected variation in demand or supply increases. Alternatively, Replenishment for Services is a method of managing capacity of services organizations on demand.

Replenishment for Services categorizes practitioners into skill groups, each of which is comprised of people with like skills and responsibilities. For example, an enterprise in the information technology field might have separate skill groups for architects, analysts, programmers, testers, project managers, consultants, partners, etc. Skill groups may be further qualified by attributes such as language, location, technology, industry and proficiency.

For each skill group, Replenishment for Services establishes a resource buffer, which is a sufficient number of practitioners to meet typical demand during the time it takes to re-supply the enterprise with additional resources. Though there are simple rules-of-thumb for rough buffer sizing, they do not always yield optimal buffer sizes. Hence, there is a need for a method and system for optimally sizing resource buffers under Replenishment for Services.

Replenishment for Services also provides procedures for buffer management, which is actions taken by resource managers to maintain the actual size of each resource buffer within thresholds established during buffer sizing. As resources are assigned to clients, a resource buffer may drop below its lower threshold, thus triggering replenishment of the buffer and an increase in capacity. As resources return from assignments, a resource buffer may rise above its upper threshold, thus triggering a reduction in the buffer and a decrease in capacity. Buffer management is most effective, however, when buffer size and thresholds are optimized.

### SUMMARY OF THE INVENTION

An object of this invention is to improve methods and systems for sizing resource buffers in organizations that perform services.

Another object of the present invention is to skew thresholds around a resource buffer, in an organization that performs services, to increase revenue and reduce cost via buffer management.

These and other objectives are attained with a method of and system for sizing service resource buffers. The method comprises the step of providing a model for determining a buffer size and upper and lower thresholds for said buffer, said model including a plurality of parameters and constraints. Values for said parameters are entered into the model, and the model is solved. The method comprises the further steps of identifying at least one most sensitive of said parameters of said model, calibrating said at least one most sensitive of said parameters, and after said calibrating step, re-solving the model to calculate the buffer size and the upper and lower thresholds for said buffer.

With a preferred embodiment of the invention, one of said parameters is a net resource consumption, and the step of re-solving the model includes the step of re-solving said model to calculate warning levels within said buffer. Also, the preferred implementation comprises the further step of translating said threshold levels and said warning levels from net consumption to buffer levels. The method may further comprise the steps of, when an actual buffer level is beyond one of the warning levels yet within a corresponding one of said threshold levels, developing a plan to change the amount of resources in said buffer; and when said actual buffer level is beyond said corresponding one of said threshold levels, executing said plan to change the amount of resources in said buffer.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 is a flow chart showing a preferred implementation of the present invention.

FIG. 2 illustrates how Replenishment for Services works for one resource pool.

FIG. 3 is a cost-probability chart for non-constrained resources.

FIG. 4 is an expected value chart for non-constrained resources.

FIG. 5 is a buffer level chart for non-constrained resources.

FIG. 6 is a cost-probability chart for capacity-constrained resources.

FIG. 7 is an expected value chart for capacity-constrained resources.

FIG. 8 is a buffer level chart for capacity constrained resources.

### DETAILED DESCRIPTION OF THE PREFERRED EMBODIMENTS

The present invention relates to a method and system for sizing resource buffers.

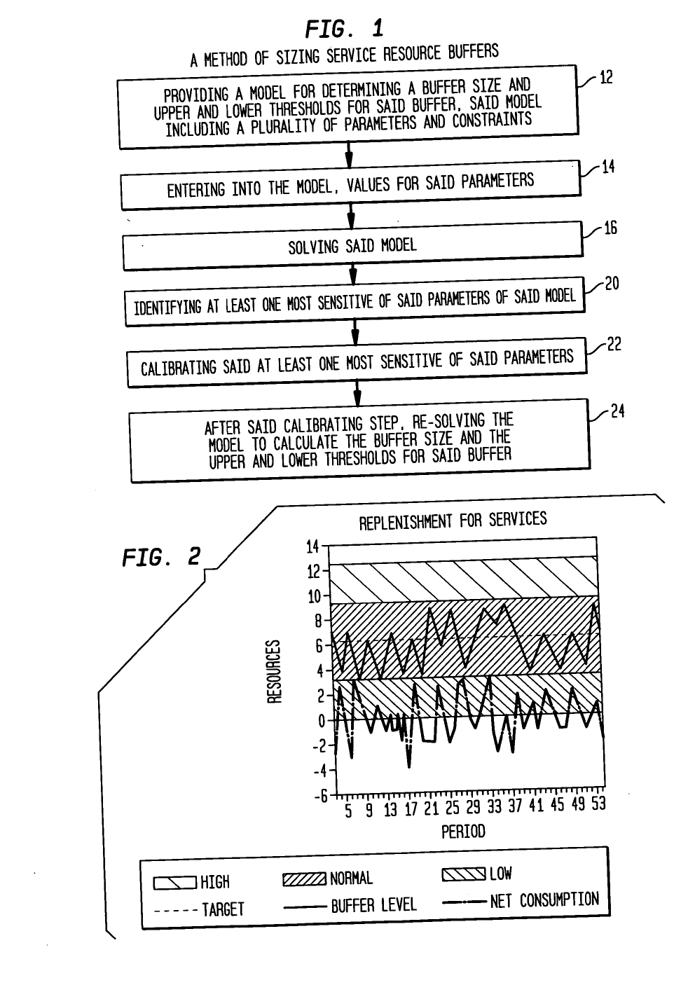

With reference to FIG. 1, the method comprises the step 12 of providing a model for determining a buffer size and upper and lower thresholds for said buffer, said model including a plurality of parameters and constraints. At step 14, values for said parameters are entered into the model; and at step 16, the model is solved. The method comprises the further steps 20. 22 and 24 of identifying at least one most sensitive of said parameters of said model, calibrating said at least one most sensitive of said parameters, and after said calibrating step, re-solving the model to calculate the buffer size and the upper and lower thresholds for said buffer.

Replenishment

Replenishment was originally a method for planning and managing the distribution of manufactured goods [It's Not Luck, by Eliyahu Goldratt, North River Press, 1994]. Contrary to conventional inventory management, which periodically pushes large shipments of inventory through the distribution system in anticipation of sales, Replenishment ships small quantities at much shorter intervals, largely in response to the pull of actual sales. Furthermore, centralized inventory exploits the statistical phenomenon of aggregation, which says that variability is significantly less at a central warehouse than at any distributed warehouse or retail location.

Since the objective is to hold just enough inventory to cover all sales during the time needed to manufacture and distribute more goods, longer manufacturing and distribution time and higher sales volatility require larger inventories. However, Replenishment typically has the dual benefit of reducing total inventory while at the same time reducing stockouts—two goals that are usually in conflict. By convention, inventories under Replenishment are called “buffers” to emphasize that they provide a buffer against uncertainty.

Replenishment for Services

Replenishment has been adapted for use in technical and professional services (See, for example, U.S. Patent Application Publication No. 2003.0125996 A1, “System and Method for Managing Capacity of Professional and Technical Services”). Some facets of Replenishment for Services are directly analogous to Replenishment for Goods.

For instance, contrary to conventional resource management, which often hires in anticipation of sales due to long hiring and training lead times, Replenishment for Services acquires resources in response to actual sales. Furthermore, centralizing resource pools, rather than hiring and training for individual engagements, exploits the statistical phenomenon of reduced volatility via aggregation. Longer hiring and training lead time and higher sales volatility require larger resource buffers, but the overall benefits are fewer idle resources and fewer open positions—two goals that are usually in conflict.

Despite these similarities between Replenishment for Goods and Replenishment for Services, there also are some differences. Table I shows some of these differences.

TABLE I

| Replenishment for . . . | goods | services |
|---|---|---|
| Thing being replenished is . . . | physical items | skilled |
| | | resources |
| Production can be done . . . | in advance | only after |
| | | service request |
| Stockouts cause . . . | backorders | lost or late |
| | | projects |
| Supply and demand are . . . | independent | coupled |
| Target buffers are based on . . . | total consumption | net consumption |
| Buffer size equals . . . | entire inventory | fraction of |
| | | total resources |
| Buffer zones are . . . | unidirectional | bidirectional |
| Buffer management means . . . | ordering more goods | increasing/ |
| | | decreasing |
| | | resources |

When goods are sold, returns are the exception, not the rule. Conversely, when resources are deployed to projects, returns are the rule, not the exception. That is, resources return to the pool of available resources after their tasks on a project are finished. Thus, supply and demand for resources are coupled.

Net consumption is new demand minus returning supply—and the result can be positive, negative, or zero. So, unlike inventory, where the target buffer size is based on total units sold during time to re-supply, target resource buffers are based on net consumption during time to acquire more resources—and the resulting buffer size is typically just a fraction of total resources.

Also, in contrast to the inventory, where a low buffer triggers action, but a high buffer level generally triggers no action, a resource buffer is bidirectional. That is, the objective is to have neither too many nor too few resources. Whereas declining sales of goods leave inventory at or near its target buffer level, declining sales of services causes resource buffers to rise to unaffordable levels. Thus, resource management must trigger decreases or increases in the actual buffer level whenever it strays too far from the target.

Example of Replenishment for Services

FIG. 2 illustrates how Replenishment for Services works for one resource pool. In a global service provider, there may be hundreds of such pools, also called skill groups, each having anywhere from a handful to thousands of resources. Any available member of a resource pool can be deployed to a project requiring that skill. And resources revert to being available when their tasks are complete.

For the pool as a whole, net consumption during any period can be positive, negative, or zero. When it is positive, the buffer level drops. When negative, the level rises. The target buffer is based on net consumption during the mean or median time it takes to acquire more resources.

This replenishment time does not necessarily equate to hiring and training new employees. It may be just the time needed to find a suitable subcontractor (i.e., days instead of months). For skills that are available virtually on demand—or if clients are willing to wait for services—the target buffer can be zero. But for a skill that takes longer to replenish than clients will wait, the buffer size usually must be some positive value. (Special cases are discussed later.)

Rule-of-Thumb for Buffer Sizing

A rule-of-thumb for buffer sizing is to set the target equal to average net consumption plus expected attrition during the time needed to re-supply. For example, if a given skill group has no attrition, requires two additional resources per month, and it takes two weeks to acquire another resource, the target buffer size should be one resource, which is computed as 2 resources per month times 0.5 months to re-supply. If time to re-supply later lengthens to a full month, the buffer would be resized to 2 resources. And if attrition increased to one per month, the buffer would again be resized to 3 resources.

Target buffer size is unrelated to the sizes of skill group, which could have anywhere from a handful to thousands of members. Mean net consumption drives the target, and skill groups of vastly different sizes can have the same mean net consumption. Also, target buffer size can be negative. If so, it indicates the number of resources that should be reduced during time to re-supply to keep the buffer aligned with declining net consumption. (Negative target buffer size does not occur in Replenishment for Goods because the buffer itself has a lower bound at zero inventory.)

Surrounding the target buffer size is the normal variability zone (shown at 32 in FIG. 2). No action is taken while the actual buffer level is in the normal zone because it will likely move toward the target buffer size on its own. But when the buffer level rises into the high zones, that is a signal to consider shedding some resources. And when it drops into the low zone, that's a signal to consider gaining resources. If the buffer level drops to a negative value, it means that some resource requests cannot be fulfilled immediately because the buffer has been depleted, and therefore re-supply will have to fulfill that backlog before the buffer level will rise above zero.

Rule-of-Thumb for Threshold Setting

The normal zone can be calibrated for different levels of sensitivity by making it wider or narrower. A rule-of-thumb for threshold setting is to set the normal zone between one and two standard deviations above and below the target buffer size in order to cover 68% to 95% of the variability in net consumption. Whenever the actual buffer level moves beyond a threshold (into region 34), the resource manager has to decide whether to adjust capacity by increasing or decreasing resources.

Thresholds do not have to be equidistant from the target buffer size. For example, if depleting the buffer for a scarce resource has a substantial impact on revenue and profit but the cost of an idle resource is relatively small, the low-zone threshold may be raised. Likewise, if it takes a long time to replace a scarce resource, the high-zone threshold may be raised as well. But regardless of how the buffer is sized and the zone thresholds are set, when replenishment time or variability of net consumption change, the target buffer and thresholds need to be adjusted accordingly.

Applicability of Replenishment for Services

Replenishment for Services does not depend on the source of demand for resources. A process, for instance, is a set of activities performed continuously or on a frequently recurring schedule with no final completion date, such as operating a data center or call center, providing maintenance or technical support, and processing payroll or tax returns. In contrast, a project is a set of finite-duration tasks that must be performed in a specified sequence to produce a desired result within a prescribed time and budget.

Resource requirements for a process are driven by the volume of work flowing through the process, and most resources have long-term assignments. On the other hand, resource requirements for a project are driven by the specific tasks within scope, so most resources have short-term assignments. Yet Replenishment for Services is applicable to both processes (See, for example, U.S. patent application Ser. No. 11/055,403, filed Feb. 10, 2005 for “Method and System for Managing Business Processes On Demand with Drum Buffer Rope,”) and projects (See, for example, U.S. patent application Ser. No. 11/046,373, filed Jan. 27, 2005 for “Method and System for Planning and Managing Multiple Projects on Demand With Critical Chain and Replenishment”). The disclosures of the two above-identified patent application Ser. Nos. 11/055,403 and 11/046,373 are herein incorporated by reference in their entireties.

As discussed above, this invention is a method and system for sizing resource buffers under Replenishment for Services. The system includes a model, which preferably is an optimization model. The method includes steps to prepare, solve and calibrate the model, and then make decisions based on it.

An optimization model is useful in this context because actual conditions in a services enterprise do at times depart from the assumptions underlying rules-of-thumb for buffer sizing and threshold setting. And the more inputs deviate from those assumptions, the better an optimal solution can look.

Assumptions

The rules-of-thumb explained earlier enable buffer sizing and threshold setting with just the knowledge of average net consumption during mean or median time to re-supply. But by incorporating additional information into the solution, this invention relaxes some implicit assumptions behind the rules-of-thumb, and thereby improves the solution.

Net Consumption

Net consumption of resources in a services business is approximately normally distributed even if the distributions of demand and supply are skewed. If sales are strongly trending upward or downward, resource demand and supply skew in opposite directions, thus amplifying net consumption. However, this shifts the mean more than it affects the standard deviation or shape of the distribution. Moreover, the shorter the time to re-supply is, the less impact trend has on skew. Hence, normality is a relatively safe assumption. Nonetheless, this invention may be used to produce an optimal solution even when net consumption is significantly skewed because the actual distribution of net consumption is an inherent part of the optimization model.

Of somewhat greater concern is that Replenishment assumes relatively homogenous net consumption, yet it may become “lumpy” if very large engagements occur or if a substantial number of engagements have synchronized start or finish dates. That is, large engagements tend to acquire, and later release, many resources at once, which can generate outliers in the distribution of net consumption. Likewise, if engagements usually start on a Monday and end on the last day of the month, those days will be peak days for resource deployment and return. Fortunately, returns and reassignments due to synchronized start or finish dates tend to wash out within the mean or median time to re-supply rather than generate extreme outliers. Of course, no buffer based on typical conditions can fully protect against atypical conditions, but resource managers and project managers can take actions, described below, to mitigate the effects of lumpy net consumption.

Costs

The assumption underlying the rules-of-thumb most likely to be incorrect is having too many resources costs the same as having too few. It's easy to assume that having too many resources costs more than having too few, but this assumption is not necessarily true either when the impact on revenue is considered. Thus, both assumptions can be incorrect for several reasons:
a) In a profit-seeking enterprise, the revenue a resource can produce is generally higher than its labor cost. Likewise, in a governmental or non-profit organization, the value produced by a resource should be higher than its labor cost. Thus, revenue or value lost due to insufficient resources are opportunity cost, which is typically higher than labor costs.
b) If resources B, C and D are available, but they depend on resource A and it is unavailable, then the revenue or value lost on those dependent resources are leverage cost. When it occurs, leverage cost for a resource is often much larger than its opportunity cost.
c) If the service provider has insufficient resources to achieve a service level agreement (e.g., X % of calls answered within 20 seconds or Y % of transactions completed without error), penalty cost may be incurred, and it can be nonlinear with respect to resources.
d) For a given resource type, hiring cost and severance cost are rarely the same. Moreover, for many resource types, their time to re-supply is short enough that their hiring and severance costs are substantially greater than their labor and opportunity costs.

These differences mean that an optimal “no action” zone around the target buffer size can be asymmetric. And as the zone becomes more asymmetric, the optimal target buffer size itself may move away from average net consumption during time to re-supply. This bias, thus, compensates for differences in cost.

Other Factors

Several factors determine the conditions under which the costs outlined above occur. Some of those factors are under resource manager control, but others are not.

Attrition (loss of resources through resignation, retirement, or death) decreases severance cost but increases hiring cost. Unfortunately, attrition and net consumption are positively correlated. So unless attrition drops to zero, net consumption greater than or equal to zero results in on-going hiring cost. On the other hand, attrition naturally decreases capacity during periods of negative net consumption. Hence, the effect of attrition can be detrimental or beneficial to resource management.

Transfers, if feasible, move resources between skill groups, and thereby alleviate imbalances. If the skill groups are highly compatible, transfers may impose little or no cost. But to the degree that the skill groups are incompatible, transfers can lead to transfer cost in the sending and/or receiving skill group, due to retraining and perhaps relocations. From a resource management perspective, however, the overall effect of transfers is often beneficial, despite the cost.

Full-time equivalents (FTEs) can be substantially different from resource head count, so optimization is best done on FTEs. For example, each of three resources working half time, represent a head count of 3, but only 1.5 FTEs. Conversely, each of three resources working 25% paid overtime represent 3.75 FTEs. However, each of three resources working 20% unpaid overtime may nonetheless represent only 3.0 FTEs if overtime is inherent in their jobs, as is often the case with salaried positions.

System

In general, an optimization model is a set of formulas, which can be solved to determine the inputs that maximize or minimize an objective, subject to parameters and constraints. Inputs exert their influence on the objective via computations, which are in turn governed by the parameters and constraints.

The Model

In this invention, the model is preferably implemented as follows:
1. Objective=minimize total expected cost
2. Inputs=target buffer size, upper threshold, lower threshold
3. Constraints=lower threshold≦target buffer size≦upper threshold and optionally, values must be integers
4. Parameters
   a. Excess resource cost rate
   b. Shortage resource cost rate
   c. Transfer resource cost rate
   d. Leveraged resource cost rate
   e. Severed resource cost rate
   f. Hired resource cost rate
   g. Penalty cost formula
   h. Mean or median time to re-supply
   i. Distribution of net consumption
      i. If normal, mean and standard deviation of net consumption during time to re-supply
      ii. If not normal, suitable parameters of the distribution
   j. Attrition during time to re-supply
   k. Transfers during time to re-supply
   l. Warning width
5. Computations
   a. Excess resources
   b. Shortage resources
   c. Transfer resources
   d. Probability of each level of net consumption
   e. Excess cost
   f. Shortage cost
   g. Transfer cost
   h. Severance cost
   i. Hiring cost
   j. Penalty cost
   k. Total expected cost=sum of costs time probability
   l. Warning levels

If no integer constraints are used, the solution usually results in fractional FTEs, which are accommodated by part-time or overtime work. On the other hand, if integer constraints are used, the optimal solution is not necessarily equivalent to rounded non-integer input values.

Typical effects of changes in parameters are shown in Table II.

TABLE II

| Parameters | Effects |
|---|---|
| Mean of net consumption increases | Target buffer size increases |
| Standard deviation of net consumption increases | Thresholds widen |
| Attrition increases (supply decreases) | Target buffer size increases |
| Time to re-supply increases | Mean of net consumption increases |
| Shortage cost > Excess cost | Target & thresholds shift to avoid shortage cost |
| Leverage cost > Shortage cost | Target & thresholds shift to avoid leverage cost |
| Severance cost > Hiring cost | Target & thresholds shift to avoid severance cost |
| Transfers in increase | Target buffer size decreases |
| Transfers out increase | Target buffer size increases |

Hence, some parameter changes can diminish or amplify the effects of other parameter changes.

Method

The method includes steps to prepare, solve, and calibrate the model, and then perform buffer management according to the solution:
1. Enter parameters and constraints into the model.
2. Solve the model.
3. Calibrate the most-sensitive parameters, then repeat the previous step.
4. Whenever parameters or constraints change, repeat all the previous steps.
5. Translate the thresholds and warning levels from net consumption to buffer levels.
6. When the actual buffer level is within the warning levels, do nothing.
7. When the actual buffer level is beyond a warning level yet within the corresponding threshold, plan to increase or decrease resources.
8. When the actual buffer level goes beyond a threshold, decide whether to execute the plan to increase or decrease resources.

Solving the model means executing software, which computes an optimal solution using algorithms, such as reduced gradient or branch-and-bound. That software may produce reports that assist in identifying which parameters are most sensitive.

Calibrating the model means to increase the accuracy of its parameters in order to ensure a good solution without unnecessary tuning. For instance, if a small change in severance cost rate changes the solution significantly, that rate should be as accurate as possible. Conversely, if a large change in shortage cost rate has little effect on the solution, its accuracy is not as important.

Translating the thresholds and warning levels means reflecting them around the target buffer size because net consumption and actual buffer levels move in opposite directions. For example, if the target buffer is 2 and the threshold for resource shortage is 5 units of net consumption, the translated resource shortage threshold is an actual buffer level of −1 (i.e., 5−2=3, so 2−3=−1).

Buffer sizing and threshold setting are based on net consumption because it is purely new demand minus returning supply during time to re-supply. In contrast, the actual buffer levels are also affected by resource manager decisions, so that the data is affected by the very decisions it would be intended to support.

Translation to buffer levels is done because net consumption is sensitive to the interval between measurements, while the actual buffer level is not. Since buffer management generally needs to be done more often than the time to re-supply, buffer management is done with actual buffer levels even though buffer sizing is done with net consumption.

Deciding whether to increase or decrease resources is not generally automated because the resource manager has to (a) judge whether changes are transient or enduring and (b) determine the best course of action. For instance, the manger may be aware of market forces or strategic initiatives, which have not yet fully affected net consumption. Ideally, no opposing resource decisions occur in sequence, and capacity ratchets up or down smoothly. One way to minimize regret is to require the actual buffer level to stay beyond the threshold for more than one buffer management decision cycle. Another way is to increase or decrease resources just enough to get the buffer level back into the normal zone because regression to the mean will tend to re-center it naturally. And increasing or decreasing resources are typically not the only possible actions: expediting, substitution and overtime may all be viable alternatives.

Example of Optimal Buffer Sizing for Non-Constrained Resource

Consider a skill group with the following characteristics:
Resources are readily available, so this skill groups is never a constraint on the enterprise
Mean time to re-supply is 10 working days
Net consumption is normally distributed with mean of 1 and standard deviation of 5
Attrition is 1, but potential transfers from other groups is 2
Shortage costs more than excess
Severance costs more than hiring
Leverage and penalty costs are zero
Buffer size and thresholds are constrained to integers.

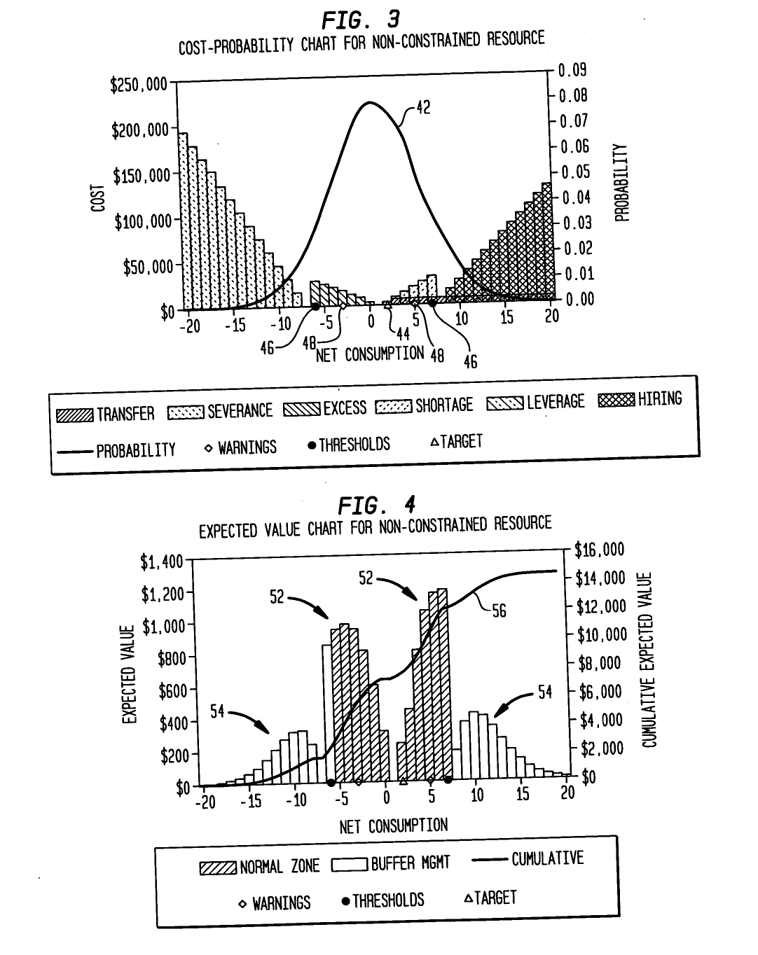

FIG. 3 shows several kinds of information for this skill group:
For each level of net consumption, stacked bars show costs against the left axis.
The line 42 shows the probability for each level of net consumption against the right axis.
On the horizontal axis, the small triangle 44 indicates the optimal buffer size is 2, the filled circles 46 indicate the thresholds are 7 and −6, and the diamonds 48 indicate the warning levels are 5 and −3. Hence, the target buffer does not equal mean net consumption, and the thresholds are not symmetric around the target.

It may be noted that large changes in net consumption have high cost, yet low probability. This relationship generates an entirely different pattern in FIG. 4. Specifically, FIG. 4 shows expected values, which are computed as cost times probability for each level of net consumption:
Dark bars 52 in the middle are the normal or “no action” zone.
Light bars 54 on the left and right are buffer management zones, which correspond to increases or decreases in capacity.
The line 56 shows cumulative expected value against the right axis.

The buffer size and thresholds shown in FIG. 4 are optimal because they minimize the expected value of all costs. So long as the assumptions underlying the model hold, net consumption should fall in the normal zone about 84% of the time, there will be excess about 6% of the time, and shortage about 10%.

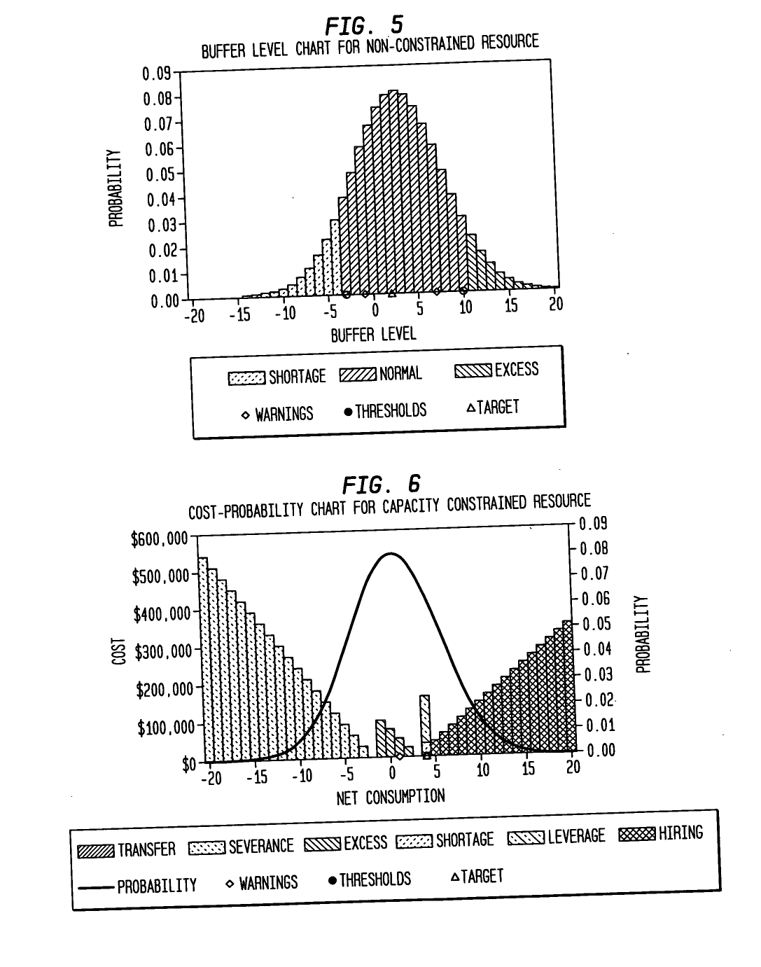

After the thresholds and warning levels are translated from net consumption to buffer levels, as shown in FIG. 5, the resource manager would consider reducing resources if the actual buffer level rose above 10 and consider increasing resources if it fell below −3. A negative buffer level means there are outstanding requisitions that cannot be fulfilled immediately. Thus, this solution tolerates resource shortages (buffer levels between −1 and −3) about 15% of the time.

Example of Optimal Buffer Sizing for Capacity Constrained Resource

Now consider a skill group with these characteristics:
Resources are not readily available, so this skill group is occasionally a constraint on the enterprise
Mean time to re-supply is 6 weeks
Net consumption is normally distributed with mean of 1 and standard deviation of 5
Attrition is 1, but transfers from other groups are not feasible
Shortage costs more than excess
Leverage costs are much greater than shortage costs, but penalty costs are zero
Severance costs more than hiring
Excess and shortage costs are higher than those for the non-constrained resource
Buffer size and thresholds are constrained to integers

FIG. 6 shows the optimal buffer size is 4, and the thresholds are 4 and −1. Therefore, as before, the target buffer size does not equal mean net consumption, and the thresholds are not symmetric around the target. Moreover, in this case, the upper threshold coincides with the target buffer, thereby indicating a strong bias against shortages because they cost far more than the buffer.

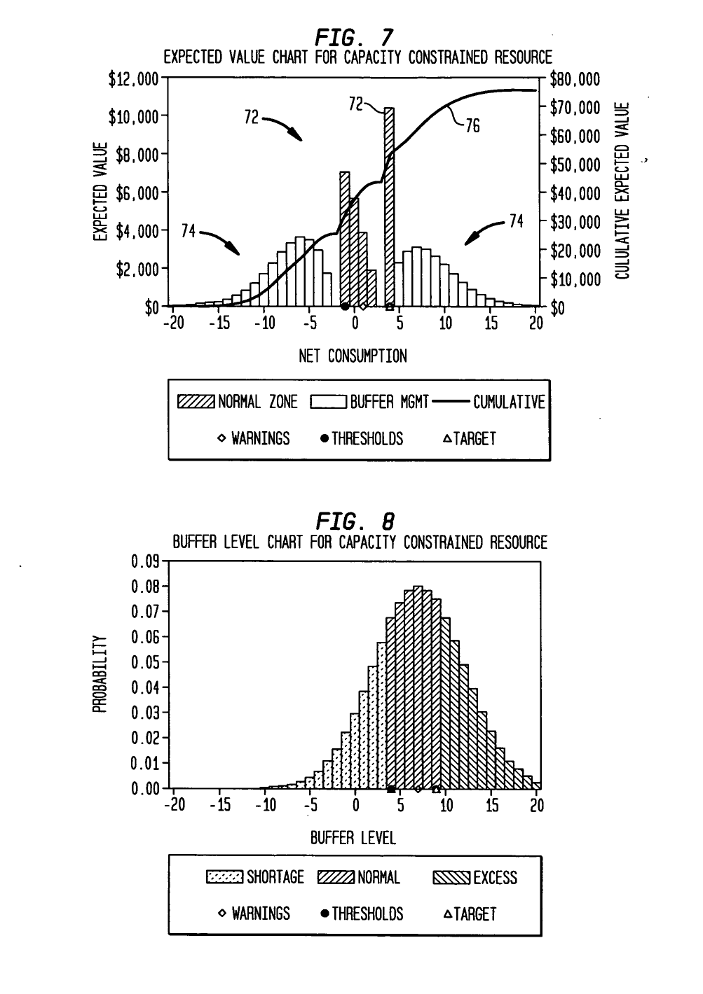

FIG. 7 shows expected values, which are computed as cost times probability for each level of net consumption:
Dark bars 72 in the middle are normal or “no action” zone.
Light bars 74 on the left and right are buffer management zones, which correspond to increases or decreases in capacity.
The line 76 shows cumulative expected value against the right axis.

So long as the assumptions underlying the model hold, net consumption should fall in the normal zone about 45% of the time, there will be excess about 31% of the time, and shortage about 24%.

After the thresholds and warning levels are translated from net consumption to buffer levels, as shown in FIG. 8, the resource manager would consider reducing resources if the actual buffer level rose above 9 and consider increasing resources if it fell below 4. Hence, “shortage” in this case does not mean “zero resources.” Indeed, unlike the previous example for a non-constrained resource, which tolerated some negative buffer levels, this solution does not even tolerate some positive buffer levels because the cost of shortages is quite high.

Special Cases

The following special cases generate unusual buffer sizes and/or threshold settings.

Time to Re-Supply is Negligible

Whenever time to re-supply is within the time clients will wait for service, target buffer size drops to zero. This commonly occurs when subcontractors can rapidly fulfill requests for commodity skills. But it can also occur when the job market is soft and skilled resources are plentiful. And it can occur when clients approve an engagement but delay the start date, such as to the start of the next fiscal year.

Standard Deviation of Net Consumption is Negligible

Whenever the standard deviation of net consumption is negligible, threshold settings collapse to the target buffer size. This is not common, but it can occur when resources are already assigned to lengthy engagements and few, if any, new engagements are being started.

As indicated hereinabove, it should be understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

What is claimed is:

1. A method of sizing service resource buffers, comprising the steps:
providing a model for determining a buffer size and upper and lower thresholds for said buffer, said model including a plurality of parameters and constraints;
entering into the model values for said parameters;
solving said model;
identifying at least one most sensitive of said parameters of said model;
calibrating said at least one most sensitive of said parameters; and
after said calibrating step, re-solving the model to calculate the buffer size and the upper and lower thresholds for said buffer.

2. A method according to claim 1, wherein one of said parameters is a net resource consumption, and the step of re-solving the model includes the step of re-solving said model to calculate warning levels within said buffer.

3. A method according to claim 2, comprising the further step of translating said threshold levels and said warning levels from net consumption to buffer levels.

4. A method according to claim 3, comprising the further step of when an actual buffer level is beyond one of the warning levels yet within a corresponding one of said threshold levels, develop a plan to change the amount of resources in said buffer.

5. A method according to claim 4, comprising the further step of when said actual buffer level is beyond said corresponding one of said threshold levels, executing said plan to change the amount of resources in said buffer.

6. A system for sizing service resource buffers, comprising:
a model for determining a buffer size and upper and lower thresholds for said buffer, said model including a plurality of parameters and constraints;
means for entering into the model values for said parameters;
means for identifying at least one most sensitive of said parameters of said model;
means for calibrating said at least one most sensitive of said parameters; and means for solving said model, and then, after calibrating said at least one most sensitive of said parameters, re-solving the model to calculate the buffer size and the upper and lower thresholds for said buffer.

7. A system according to claim 6, wherein the means for calibrating includes means to increase the accuracy of said at least one most sensitive of said parameters.

8. A system according to claim 6, wherein:
one of said parameters is a net resource consumption;
the means for solving includes means to calculate a buffer size, upper and lower thresholds for said buffer, and warning levels for said buffer; and
further comprising means for translating said threshold levels and said warning levels from net consumption to buffer levels.

9. A system according to claim 8, wherein the means for translating includes means for reflecting said threshold levels around a target buffer size.

10. A system according to claim 8, wherein said net resource consumption is new demand minus returning supply.

11. A program storage device readable by machine, tangibly embodying a program of instructions executable by the machine to perform method steps for sizing service resource buffers, said method steps comprising:
enabling a model for determining a buffer size and upper and lower thresholds for said buffer, said model including a plurality of parameters and constraints;
entering into the model values for said parameters;
solving said model;
identifying at least one most sensitive of said parameters of said model;
calibrating said at least one most sensitive of said parameters; and
after said calibrating step, re-solving the model to calculate the buffer size and the upper and lower thresholds for said buffer.

12. A program storage device according to claim 11, wherein:
one of said parameters is a net resource consumption;
the step of re-solving the model includes the step of re-solving said model to calculate warning levels within said buffer; and
the method steps further comprise the step of translating said threshold levels and said warning levels from net consumption to buffer levels.

13. A program storage device according to claim 12, wherein said translating step includes the step of reflecting said threshold levels around a target buffer size.

14. A program storage device according to claim 11, wherein the method steps comprise the further steps of:
when an actual buffer level is beyond one of the warning levels yet within a corresponding one of said threshold levels, developing a plan to change the amount of resources in said buffer; and
when said actual buffer level is beyond said corresponding one of said threshold levels, executing said plan to change the amount of resources in said buffer.

15. A program storage device according to claim 11, wherein the calibrating step includes the step of increasing the accuracy of said at least one of said parameters.

16. A method of deploying a computer program product for sizing service resource buffers, wherein, when executed, the computer program performs the steps of:
enabling a model for determining a buffer size and upper and lower thresholds for said buffer, said model including a plurality of parameters and constraints;
entering into the model values for said parameters;
solving said model;
identifying at least one most sensitive of said parameters of said model;
calibrating said at least one most sensitive of said parameters; and
after said calibrating step, re-solving the model to calculate the buffer size and the upper and lower thresholds for said buffer.

17. A method according to claim 16, wherein:
one of said parameters is a net resource consumption;
the step of re-solving the model includes the step of re-solving said model to calculate warning levels within said buffer;
the method steps further comprise the step of translating said threshold levels and said warning levels from net consumption to buffer levels; and
said translating step includes the step of reflecting said threshold levels around a target buffer size.
